(19) United States
(12) Patent Application Publication
(10) Pub. No.: US 2010/0301147 A1
(43) Pub. Date: Dec. 2, 2010

(54) MEDICAL WASTE PROCESSING INCLUDING DENSIFICATION

(76) Inventors: James R. Harkess, Studio City, CA (US); Thomas Harkess, Burbank, CA (US); Karl Niemiec, Carmel, IN (US)

Correspondence Address: MINTZ, LEVIN, COHN, FERRIS, GLOVSKY AND POPEO, P.C, ONE FINANCIAL CENTER, BOSTON, MA, 02111, US

(21) Appl. No.: 12/789,396

(22) Filed: May 27, 2010

Related U.S. Application Data
(60) Provisional application No. 61/181,618, filed on May 27, 2009.
(60) Provisional application No. 61/185,566, filed on Jun. 9, 2009.

(51) Int. Cl. B02C 21/00; F27D 15/00

(52) U.S. Cl. 241/23; 432/86

(57) ABSTRACT

The subject matter disclosed herein provides methods and apparatus for processing medical waste to form feedstock useable in the manufacture of other products, such as diesel, gas, plastics, and the like. In one aspect there is provided a method. The method may heat the medical waste to sanitize the medical waste; provide the sanitized medical waste to a densifier; and process, at the densifier, by heating and shredding the sanitized medical waste to form a feedstock. Related systems, apparatus, methods, and/or articles are also described.

### CROSS REFERENCE TO RELATED APPLICATION

This application claims the benefit under 35 U.S.C. §119(e) of the following provisional applications, which are incorporated herein by reference in their entirety: U.S. Ser. No. 61/181,618, entitled “Medical Waste Processing Including Densification,” filed May 27, 2009 (Attorney Docket No. 36707-504P01 US) and U.S. Ser. No. 61/185,566, entitled “Medical Waste Processing Including Densification,” filed Jun. 9, 2009 (Attorney Docket No. 36707-504P02US).

### FIELD

This disclosure relates generally to waste and, in particular, medical waste.

### BACKGROUND

The handling, disposal, and recycling of waste in a safe and ecologically responsible manner is always a concern. In the case of medical waste, handling, disposal, and recycling are more problematic due to the hazardous substances, such as bacteria and viruses typically found in medical waste. For example, medical waste may include one or more of the following: plastic, glass, paper, cloth, small amounts of metal, pathological material, and the like. Although handling and separating waste to facilitate recycling is now commonplace, manually separating and recycling medical waste is not considered a viable option due to the hazardous nature of manual medical waste separation and the cost of such separation and recycling.

### SUMMARY

The subject matter disclosed herein provides methods and apparatus, for treating medical waste into a feedstock useable in the manufacture of other products.

In one aspect there is provided a method. The method may heat the medical waste to sanitize the medical waste; provide the sanitized medical waste to a densifier; and process, at the densifier, by heating and shredding the sanitized medical waste to form a feedstock.

In another aspect there is provided a system. The system may include a heat-treatment apparatus configured to sanitize medical waste; a coupler configured to receive sanitized waste and transport the sanitized medical waste; and a densifier to process the sanitized medical waste into a feedstock.

In yet another aspect there is provided a computer-readable storage medium. The computer-readable storage medium may include instructions which when executed by a processor provides operations controlling one or more of the following: heating the medical waste to sanitize the medical waste; providing the sanitized medical waste to a densifier; and processing, at the densifier, by heating and shredding the sanitized medical waste to form a feedstock.

One or more of the above-noted aspects may further include one or more of the following features. The densifier may heat and shred the sanitized medical waste by spinning the sanitized medical waste. The densifier may cool the heated sanitized medical waste to form the feedstock. The densifier may cool the heated sanitized medical waste by adding, when the sanitized medical waste is at a temperature of about 205 degrees Celsius, a cooling fluid to the sanitized medical waste. The feedstock may be provided to a reactor configured to generate a petrochemical product, a diesel fuel, and/or a gasoline fuel. The feedstock may be mixed with virgin resins for plastic products manufacturing. The medical waste may comprise one or more of the following: polyethylene, polypropylene, polystyrene, nylon, polyurethane, and polyamides. The feedstock may be provided to a reactor. The feedstock may be heated to a temperature between about 400 degrees Celsius and about 500 degrees Celsius to form a petrochemical product. The densifier may include a deodorizer. The coupler may include a transport element, a heater, and a moisturizer. The reactor may include the feedstock, which is heated to a temperature between about 400 degrees Celsius and about 500 degrees Celsius to convert the feedstock into a petrochemical product.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWING

These and other aspects will now be described in detail with reference to the following drawings.

FIG. 1 depicts a system for processing waste into feedstock;

FIG. 2 depicts a waste heat-treatment apparatus used to process medical waste;

FIG. 3 depicts an implementation of a system including a waste heat-treatment apparatus, a coupler, and a densifier;

FIG. 4 depicts a process for treating medical waste to form a feedstock;

FIG. 5 depicts a process for receiving sanitized medical waste and providing a petrochemical, such as diesel, gasoline, or plastic;

FIGS. 6-8 depict additional examples of waste heat-treatment apparatuses used to process medical waste;

FIG. 9A depicts an example of sanitized waste output by a waste heat-treatment apparatus;

FIG. 9B depicts an example of the substantially dry, crystal-like feedstock output by a densifier; and

FIG. 10 depicts an example of a reactor used to process the substantially dry, crystal-like feedstock into another product, such as a petroleum product.

Like reference symbols in the various drawings indicate like elements.

### DETAILED DESCRIPTION

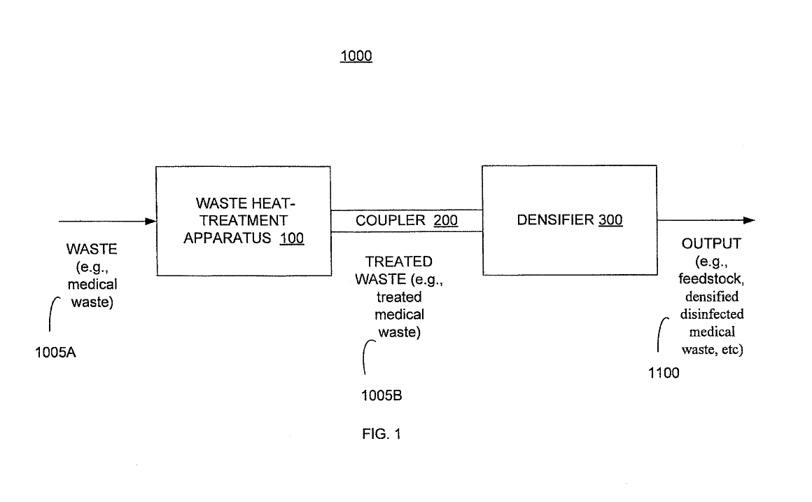

FIG. 1 depicts a system 1000 including a waste heat-treatment apparatus 100 configured to process waste 1005A, a coupler 200, and a densifier 300. The waste heat-treatment apparatus 100 (which is further described below) receives waste 1005A (e.g., medical waste, etc.) and processes the waste to form treated waste 1005B. The waste 1005A is moved through the waste heat-treatment apparatus 100 using transport mechanisms, and heat is applied to the waste 1005A using, for example, microwaves and steam. The heat may be applied to remove hazardous and/or harmful aspects of the waste, including one or more of the following: bacteria, viruses, mycobacterium, and the like typically found in waste and, in particular, medical waste. The treated waste 1005B may be in the form of waste that has been sanitized to substantially remove any bacteria or viruses and shredded into small particles having a size of about 5 centimeters or less.

The sanitized, treated wasted 1005B is transported via the coupler 200 to the densifier 300 to form an output 1100, which is also referred to herein as densified, disinfected medical waste or as feedstock. The densifier 300 processes the treated waste 1005B to form the feedstock 1100 by further reducing the size of the treated waste 1005B and/or heating the treated waste 1005B. In some implementations, the densifier 300 processes the waste to form a compound that has small particles, which have the appearance of dry flakes or crystals. The heat provided by the densifier 300 dries the treated waste 1005B within the densifier 300 and, in some implementations, forms crystals using a quenching phase described below.

The feedstock 1100 may be used as a raw material in a variety of processes and/or products. As such, the system 1000 provides a useful mechanism to convert waste, including harmful medical waste, into a feedstock that may be recycled. Moreover, separation of the plastics within the medical waste 1005A is not necessary as the waste heat-treatment apparatus 100 does not require waste separation. The feedstock 1100 may be used in the manufacture of products including plastics, lumber, fuels, grease, gas, diesel, bio-diesels, and the like.

In some implementations, the feedstock 1100 may be used as an input to a reactor, wherein the feedstock 1100 undergoes decomposition into one or more intermediary substances, which may in some implementations include one or more gas phase, organic monomers. The intermediary substance may then be used in the manufacture of, for example, another petrochemical end product, such as for example diesel fuel, one or more plastics, other polymeric products, etc. The chemical composition of the one or more intermediary substances may vary depending on the composition of the feedstock, which in turn depends on the composition of the waste 1005A. Possible processes by which the feedstock may be converted to useful end products are described in greater detail below.

Although the waste 1005A may include a variety of substances, in some implementations, the waste is limited to medical waste. Medical waste may include one or more of the following: (1) cultures and stocks of infectious agents and associated biologicals, including cultures from medical and pathological laboratories, cultures and stocks of infectious agents from research and industrial laboratories, wastes from the production of biologicals, discarded live and attenuated vaccines, and culture dishes and devices used to transfer, inoculate, and mix cultures; (2) pathological wastes, including tissues, organs, and body parts that are removed during surgery or autopsy; (3) waste human blood and products of blood, including serum, plasma, and other blood components; (4) sharps that have been used in patient care or in medical, research, or industrial laboratories, including hypodermic needles, syringes, Pasteur pipettes, broken glass, and scalpel blades; (5) contaminated animal carcasses, body parts, and bedding of animals that were exposed to infectious agents during research, production of biologicals, or testing of pharmaceuticals; (6) wastes from surgery or autopsy that were in contact with infectious agents, including soiled dressings, sponges, drapes, lavage tubes, drainage sets, underpads, and surgical gloves; (7) laboratory wastes from medical, pathological, pharmaceutical, or other research, commercial, or industrial laboratories that were in contact with infectious agents, including slides and cover slips, disposable gloves, laboratory coats, and aprons; (8) dialysis wastes that were in contact with the blood of patients undergoing hemodialysis, including contaminated disposable equipment and supplies such as tubing, fitters, disposable sheets, towels, gloves, aprons, and laboratory coats; (9) discarded medical equipment and parts that were in contact with infectious agents; (10) biological waste and discarded materials contaminated with blood, excretion, excudates or secretion from human beings or animals who are isolated to protect others from communicable diseases; (11) low-level radioactive waste used industrially and in medical procedures in laboratories and medical facilities; (12) such other waste material that results from the administration of medical care to a patient by a health care provider and is found by the administrator of the Environmental Protection Agency to pose a threat to human health or the environment; (13) documents, such as private health information protected, for example, under the Health Insurance Portability and Accountability Act (HIPAA); and (14) any other waste.

In some implementations, an analysis of the medical waste reveals that a substantial portion of that waste includes plastics. But the plastics mixed in with other medical wastes cannot be readily separated due to the harmful nature of the medical waste. Nonetheless, the system 1000 may be used to sanitize the medical waste, including any plastics, into a feedstock, without requiring separation of the plastics.

Although the feedstock provided as output 1100 may have a variety of compositions, in various implementations, the feedstock may include polyethylene, polypropylene, polystyrene, nylon, polyurethane, certain types of Bakelite-type material, and polyamides. Bakelite is a thermo-plastic based on a phenol formaldehyde resin: polyoxybenzylmethylenglycolanhydride.

An analysis of a sample of feedstock created according to the current subject matter and using medical waste materials as the input waste material was conducted using pyrolysis-gas chromatography-mass spectrometry. In this analysis, the plastic polymer molecules are broken down by rapid heating to an elevated temperature (e.g., 750° C. reached in a matter of milliseconds) under non-oxidizing conditions (e.g., under nitrogen gas). The gas-phase monomer molecules are separated by gas chromatography and then chemically identified and quantified by mass spectrometry. For a sample of waste, the feedstock included approximately 80% by weight of polyethylene and polypropylene, with polyethylene accounting for approximately 80-90% of this fraction (e.g., about 65-75% of the bulk). Polystyrene accounted for approximately 5-10%, with the remaining 5-10% being nylon, polyurethane, Bakelite-type material, and polyamides.

The densifier 300 (also referred to as an agglomerator) is generally used to reduce the volume of the treated waste 1005B (which is provided by the waste heat-treatment apparatus 100 and coupler 200) by spinning the treated waste 1005B and cutting (e.g., shredding) the treated waste 1005B. The spinning provided by the densifier 300 also generates heat. At a given point in time, water may sprayed on the treated waste within the densifier 300 to reduce temperature, yielding a quenching process that shatters, or breaks, the treated waste 1005B in the densifier 300 into small particles, which may be used as the feedstock 1100. For example, the densifier 300 may spin the waste for about 5 to 7 minutes to attain a temperature of about 205 degrees Celsius, at which point cool water is injected into the densifier 300 to quench the waste inside the densifier 300. In some implementation, the water has a temperature of about 15 degrees Celsius and quenching occurs for about 10 seconds. The densifier 300 may also be used to process out (i.e., reduce) the content of any cellulose found in the treated waste 1005B.

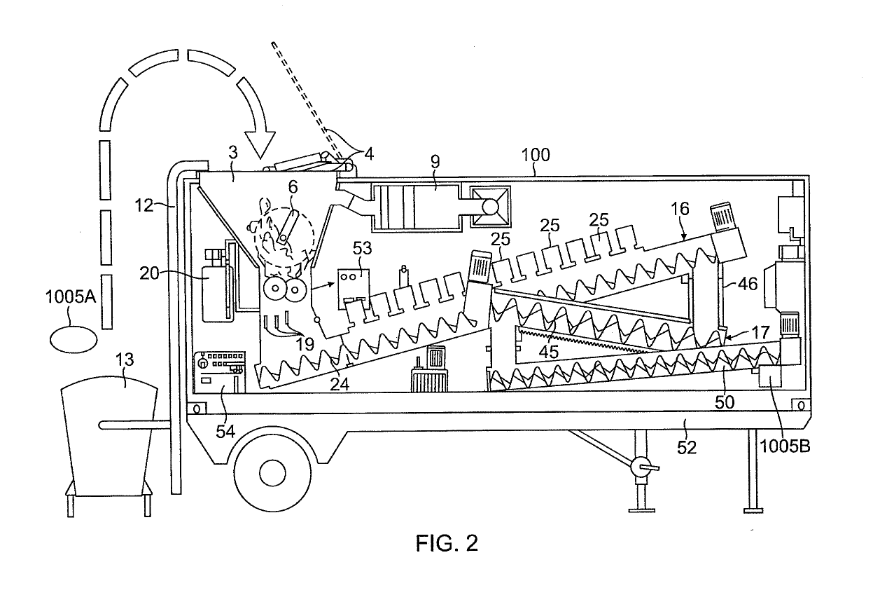

FIG. 2 illustrates an example implementation of the waste heat-treatment apparatus 100 suitable for use in treating medical waste 1005A to form treated waste 1005B, which is considered sanitized or disinfected, substantially free from bacteria, viruses, and/or other harmful and/or infectious substances typically found in medical waste 1005A. The medical waste 1005A may be contained in a waste container 13 and then delivered to a lift-and-tip mechanism 12. The lift-and-tip mechanism 12 may lift the waste container 13 to the opening of the loading chamber 3 and then dump the medical waste 1005A into chamber 3. Although the lift-and-tip mechanism 12 is depicted at FIG. 2, other transport mechanisms, such as a conveying helix, a screw conveyor, a conveyor system, and/or a continuous feed mechanism, may be used as well.

After dumping the medical waste 1005A into the loading chamber 3, a cover 4 may be used to provide a seal, which may be implemented as a fluid-tight seal to prevent the escape of liquids, germs, and other substances. To further inhibit the emission of germs or other substances into the atmosphere, the waste heat-treatment apparatus 100 may include a suction system 9. The suction system 9 may further include a suction pump and at least one filter (e.g., a hepa-filter) to capture airborne germs. Although the waste heat-treatment apparatus 100 may be implemented in a variety of ways, in one implementation, the waste heat-treatment apparatus 100 is implemented as depicted by U.S. Pat. No. 5,270,000, which is hereby incorporated by reference in its entirety.

The medical waste 1005A may be mixed in the waste container 13 prior to lifting and tipping into the loading chamber 3, although premixing may not be necessary.

The medical waste 1005A may be received at the loading chamber 3, where the waste is processed using a blade 6. The blade 6 aids in drawing the medical waste 1005A down the loading chamber 3 and cuts the waste into smaller pieces to facilitate processing.

Below the blade 6 is a waste comminutor 7. Waste cut by the blade 6 falls to the waste comminutor 7, which shreds the chopped waste into finer pieces using, for example, a pair of counter-rotating blades, although other shredding mechanisms may be used as well. In some implementations, the pieces are shredded to a size small enough to satisfy privacy concerns related to documents having private health information protected, for example, under the Health Insurance Portability and Accountability Act (HIPAA) and/or other rules and regulations. Shredding may also advantageously improve the kinetics of the various steps in the treatment and conversion process due to an increase in surface area of the waste material as well as the resulting feedstock.

After being shredded by the waste comminutor 7, the shredded medical waste is treated with moisture using one or more spray nozzles 19. The moisture may be implemented as stream, liquid, or a combination of the two. In some implementations, the moisture consists of water and/or steam (which may be generated within waste heat-treatment apparatus 100 or by an external steam source).

The moistened medical waste 1005A is then provided to a transport mechanism 24. The transport mechanism 24 may be implemented as a conveying helix, a screw conveyor, a conveyor system, a continuous feed mechanism, and/or any other mechanism that moves the waste through waste heat-treatment apparatus 100, including a microwave chamber 16, which further includes one or more microwave sources 25. The microwave sources 25 heat the moistened medical waste. For example, the microwave sources 25 may heat the medical waste to a temperature of about 95 degrees or more Celsius sufficient to kill bacteria, viruses, etc. In implementations using a conveying helix or a screw conveyor as the transport mechanism 24, the conveying helix or screw conveyor mixes the medical waste.

Moreover, in some implementations, the medical waste is further processed through a heated passage 46 to an insulated heat maintenance chamber 17 to ensure that all unwanted bacteria and viruses are dead. The medical waste is advanced through the heat maintenance chamber 17 by use of another transport mechanism labeled 45. While being transported via transport mechanism 45, the temperature of the medical waste may be maintained by adding heat (e.g., using steam, additional microwave heat, etc). The rate of conveyance via transport mechanism 45 (and through the heat maintenance chamber 17) may be adjusted to provide a sufficient temperature, pressure, and/or microwave energy delivery for a sufficient amount of time to kill all, or substantially all, of the viruses and bacteria in the waste 1005. For example, the waste must be exposed to a temperature about 95 degrees Celsius or higher for a minimum of about 30 minutes.

The medical waste is unloaded by transport mechanism 50 (which may further mix the medical waste as the waste advances through the waste heat-treatment apparatus 100), where it is output as treated wasted 1005B. The treated waste 1005B is then transported through the coupler 200 and then provided to the densifier 300.

Although FIG. 2 depicts a plurality of transport mechanisms 24, 45, and 50, the transport mechanisms may be implemented as a single transport mechanism as well. Although FIG. 2 depicts the waste heat-treatment apparatus 100 mounted on a motor vehicle trailer 52, the waste heat-treatment apparatus 100 may be configured in other ways, such as in a permanent or fixed configuration.

The waste heat-treatment apparatus 100 may also include a processor, such as a computer 54 and a space heating system 53 to provide additional heat to the waste heat-treatment apparatus 100. The computer 54 may include program code to control one or more aspects of the systems and processes described herein (e.g., processes 400, 500, and the like).

In some implementations, the waste heat-treatment apparatus 100 may be implemented to require very little water for operation. Further, the temperature of operation may be implemented to be low enough so that harmful dioxins are not generated and plastic materials are not melted. The waste heat-treatment apparatus 100 may also be implemented to not generate harmful air emissions typically associated with incinerators. In addition, the treated waste 1005B discharged from the waste heat-treatment apparatus 100 may be suitable for handling by a typical community landfill or a recycling center without additional treatment.

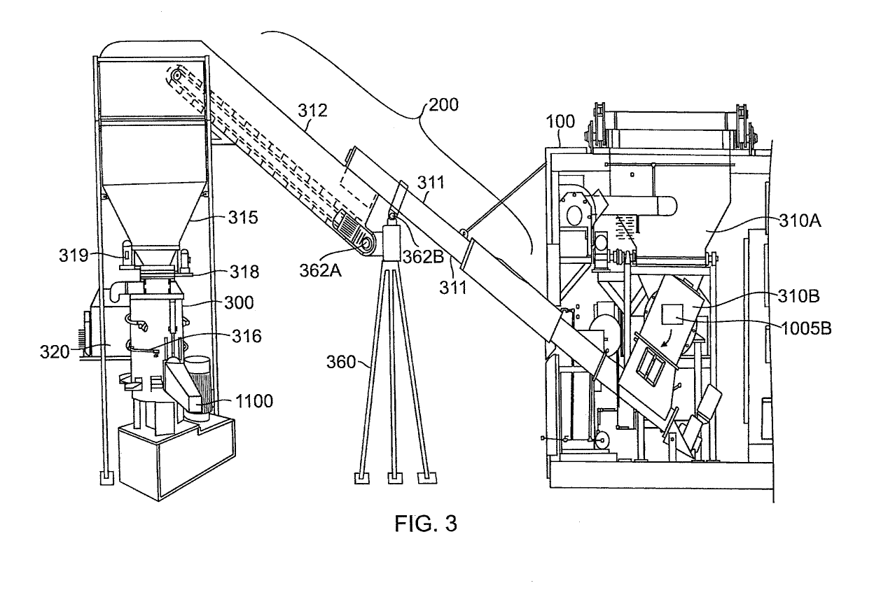

The coupler 200, depicted at FIG. 3, transports the treated wasted 1005B from the waste heat-treatment apparatus 100 to the densifier 300. In the implementation of FIG. 3, the transport mechanism 50 provides the treated waste 1005B to hoppers 310A-B, which are used to provide the treated waste 1005B to coupler 200.

The coupler 200 receives the treated waste 1005B from the transport mechanism 50 and hoppers 310A-B of waste heat-treatment apparatus 100. Moreover, the coupler 300 may include heating mechanisms and moisture mechanisms. For example, coupler 200 may include a transport mechanism, such as a screw conveyor, a conveying helix, a conveyor system, a continuous feed mechanism and the like, to move the treated waste 1005B. In the example of FIG. 3, the coupler 200 includes a screw mechanism 311, which provides the treated waste 1005B to a conveyor mechanism 312 in order to move the treated waste 1005B from the waste heat-treatment apparatus 100 to a waste collection hopper 315 at the densifier 300. The waste collection hopper 315 funnels the treated waste 1005B to the densifier 300.

Although FIG. 3 depicts coupler 200 as elevated at an incline using an adjustable pedestal 360, the coupler 200 may be positioned in other ways as well. The adjustable pedestal 360 includes pivots 362A-B to fix the position and/or elevation of the coupler 200 so that it may attach to the waste heat-treatment apparatus 100 and the densifier 300.

Once in the waste collection hopper 315, gate opener 318 is opened or closed to control the entry of treated waste 1005B into the densifier 300. The gate opener 318 may be controlled manually or by a processor, such as processor 54. The treated waste 1005B may also be vibrated using a hopper cone vibrator 319 before the treated waste 1005B passes through the gate opener 318. The cone vibrator 319 is used to break up clumps and have some flow control through the gate.

Unlike typical densifiers, densifier 300 may include one or more of the following to enhance treated waste 1005B processing: an injector 316 for disinfecting or deodorizing the waste using, for example, Odoreze™ or similar which comprises ingredients that are approved by the Food & Drug Administration (FDA) under 21 CFR-172.510 and FEMA 3121 and on the Generally Regarded as Safe (GRAS) list. An exhaust filter system 320 is incorporated to filter harmful and/or annoying fumes. In any case, the output 1100 of the densifier 300 may be reused as feedstock for other products, as further described below.

For example, the output 1100 may be used as feedstock (which is described further below) in a variety of products and/or processes. In some implementations, the feedstock may be used in a feedstock, mixed with virgin plastic, in the manufacture of plastic products such as lumber, building products, etc., gas, diesel, and the like.

The feedstock 1100 may also be used as an input to a reactor, where the feedstock is heated. The heated feedstock 1100 decomposes and the output of the reactor is a petrochemical, such as diesel, gas, plastic, etc.

For example, the feedstock 1100 may include, among other things, one or more of the following: polyethylene, polypropylene, polystyrene, as well as other plastic materials. Furthermore, the feedstock 1100 may be melted and then thermally decomposed, optionally in the presence of a catalyst, such as for example a zeolite or mettalocene catalyst. In one example, catalysts and processes such as those described in U.S. Patent Application Publication No. 2007/0083068A1 (which is incorporated herein by reference in its entirety) may be used in the decomposition of the feedstock 1100. The products of the decomposition process may be relatively short-chain hydrocarbons, for example having fewer than about 40 to 50 carbon atoms, and some implementations between about 4 and 14 carbon atoms.

In some implementations, the feedstock 1100 containing an assortment of polymeric plastic material may be converted into petroleum products using a thermal depolymerization process. A wide range of polymers or mixes of polymers, including thermoset materials and even biopolymers, may be made into fuels as well as polymers. Thermal depolymerization uses hydrous pyrolysis—heating of organic compounds to high temperatures in the presence of water—for the reduction of complex organic materials, which may include plastics, biomass, paper, and the like, into a light crude oil. The hydrous pyrolysis process mimics the natural geological processes thought to be involved in the production of fossil fuels. Under pressure and heat, long chain polymers of hydrogen, oxygen, and carbon decompose into shorter chain petroleum hydrocarbons with a maximum length of approximately 18-22 carbons.

In yet other implementations, the feedstock 1100 may be processed using a selective pyrolysis reaction in which the feedstock is heated in a controlled manner through a temperature range of about 350 to about 400 degrees Celsius over an appropriate catalyst to take advantage of differences in pyrolysis rates for the various polymers expected to be found in the feedstock 1100. The plastic and the catalyst are separated by a screen. The catalyst is on a solid support. Nitrogen flow is maintained to keep the whole reaction under an inert atmosphere. The furnace is heated to about 400 degrees Celsius (and a maximum temperature of about 500° C.) and the fuel collects at the other end of the reactor.

Monomeric or short hydrocarbon polymer chains or other decomposition products may be recovered sequentially in the outgoing gas stream from a batch-type reactor, with the decomposition products formed from those materials in the feedstock 1100 that decompose at lower temperatures being recovered earlier in the process and the products from the feedstock materials with slower decomposition kinetics being recovered later in the process. The product may be collected, which has a boiling range of about 30 to about 90 degrees Celsius. The reactor conditions, with different catalysts and supports, may be varied to maximize production of gasoline, diesel, or other petroleum-based fuel products from the feedstock.

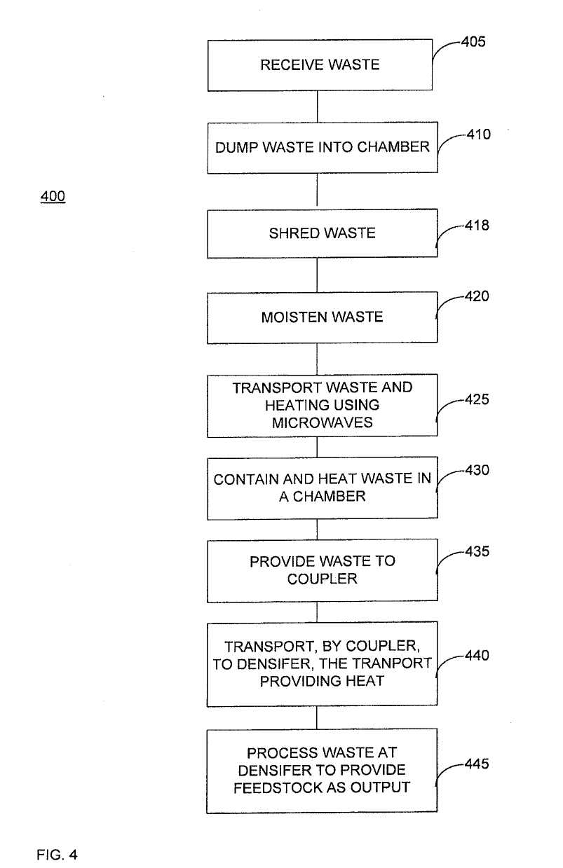

FIG. 4 depicts a process 400 for use with system 1000, although process 400 may be used with other systems as well. The description of process 400 also refers to FIGS. 1-3.

In some implementations, the waste, such as medical waste 1005A, is provided as an input to process 400, and the output of process 400 is the feedstock 1100 described herein. Moreover, the process 400 may have a yield of one gallon of gasoline or diesel for every 10 to 12 pounds of feedstock. The heat-treatment apparatus 100 has a capacity of up to 1800 pounds per hour. After densification in the densifier 300, the treated waste from a single heat-treatment apparatus 100 may support the generation of 90-100 gallons per hour of diesel or gasoline.

At 405, waste, such as medical waste 1005A, is received at the waste heat-treatment apparatus 100. The medical waste 1005A may be received via the lift-and-tip mechanism 12 or any other transport mechanism.

At 410, the received medical waste 1005A is dumped into chamber 3. Next, the medical waste 1005A is processed using blades 6 to cut the medical waste 1005A, and then the waste comminutor 7 may be used, at 418, to further shred the medical waste 1005A into smaller pieces.

At 420, the medical waste 1005A may be moistened and/or heated using steam injectors 19. For example, the waste may be moistened with steam or a liquid, such as water. Although the injectors 19 are depicted at given locations at FIG. 2, the steam injectors 19 may be located at other locations as well. Moreover, although FIG. 2 depicts 3 steam injectors 19, other quantities of steam injectors may be used as well.

At 425, the medical waste 1005A may be transported using the transport mechanism 24. During this time of transport, one or more microwave sources 25 may heat the medical waste 1005A to a temperature of about 95 degrees Celsius or higher. Although FIG. 2 depicts a given quantity of microwave heaters 25, other quantities of microwave sources 25 may be used as well.

At 430, the medical waste 1005A is transported into chamber 17. The holding chamber 17 may be used to further heat the medical waste 1005A to a temperature sufficient to kill harmful bacteria or viruses in the waste. Moreover, the chamber 17 may help break down any cellulose in paper contained in the medical waste 1005A.

At 435-440, the treated waste 1005B is provided by the waste heat-treatment apparatus 100 to coupler 200 for transport to densifier 300. The treated waste 1005B may include disinfected and/or sanitized medical waste. During transport through the coupler 200, the treated waste 1005B may be heated indirectly using steam and or direct heat (e.g., microwaves).

At 445, the densifier 300 may process the treated waste 1005B provided via coupler 200. This treated waste 1005B may first enter the waste collection hopper 315, where the treated waste 1005B is compacted using the funnel shape of the waste collection hopper 315. Next, the waste collection hopper 315 is vibrated using hopper cone vibrator 319 to further compact the treated waste 1005B. The vibration rate and material flow of treated waste may be adjusted to balance the flow of feedstock to the desired set point. For example, the feedstock rate to the system may be adjusted to maximize the reaction yield of the product desired, such as gasoline or diesel. The gate opener 318 controls the entry of the waste into the main chamber of the densifier 300 (which includes blades). Once inside the main chamber, the treated waste 1005B is processed by the blades of the densifier 300, which further heats the treated waste 1005B inside the densifier 300. Once the moisture is gone, the material temperature starts to rise to a level where the material starts to melt. At this stage, water at a given temperature is added into the densifying chamber 300. The water causes the material to suddenly solidify and the blades (still in rotation) break the solidified the material in irregular shape granules. The blade rotation may be between 800-950 rotations per minute. After about 5-10 minutes of processing the waste within the densifier 300, the treated waste 1005B is quenched for about 10 seconds using water at a temperature of about 15 degrees Celsius.

The output 1100 of the densifier is in a substantially dry crystalline (or flaked) form, which is caused by the above-noted quenching. This crystallized output 1100 may be used as the feedstock 1100.

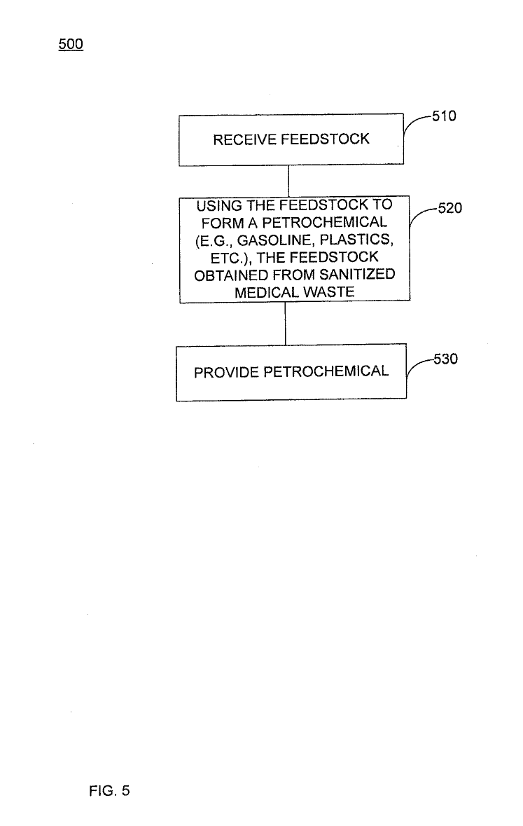

FIG. 5 depicts a process 500 for using the feedstock, which is output 1100 by process 400.

At 510, the feedstock 1100 is received at a reactor. The feedstock 1100 is formed using medical waste 1005A, sanitized to substantially remove harmful bacteria and/or viruses and processed through the densifier 300.

At 520, the feedstock 1100 is used in a process to form a petrochemical-based product. For example, the feedstock 1100 may be used at a reactor configured to process the feedstock into a petrochemical, such as plastic, diesel, gasoline, etc. In some implementations, the reactor may heat the feedstock 1100 to about 204-260 degrees Celsius. This heating, along with the addition of other catalysts, breaks down the feedstock 1100 into a petrochemical compound useable to make another petrochemical, such as gas, diesel, plastic, and the like. In various implementations, the feedstock 1100 may be processed in the reactor according to one of the process described above. Alternatively, the feedstock 1100 may be used as the starting material in any process that converts mixed organic polymer material into a useful product. For example, a catalytic pyrolysis step may generate a directly combustible fuel that may be fed to a boiler or other power generating apparatus to directly generate electricity or to power vehicles.

At 530, the reactor provides the petrochemical, such as gasoline, diesel, plastic, and the like. Thus, processes 400 and 500 may be used to recycle harmful medical waste into a petrochemical, such as gasoline, diesel, plastic, and the like. Moreover, separating any plastics within the medical waste is not necessary.

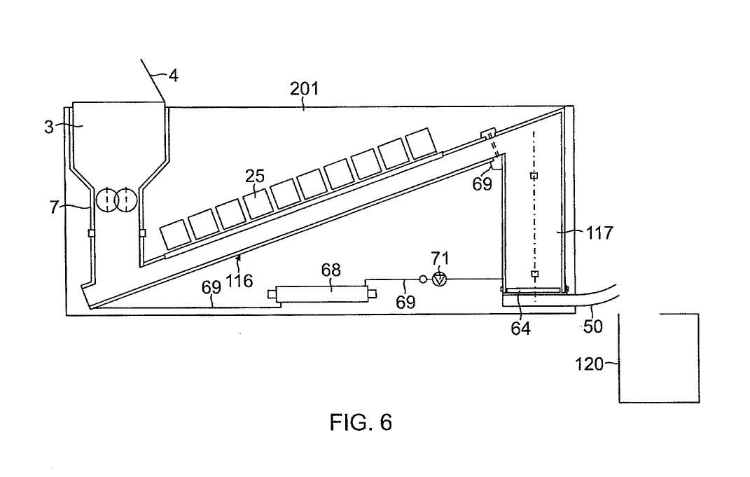

FIG. 6 illustrates another implementation of a waste heat-treatment apparatus 100. In this implementation, the waste treating apparatus 201 is configured for continuous treatment of waste. That is, the medical waste 1005A is continuously fed into the waste treating apparatus 201. This may be accomplished through a conveyor system or any other continuous feed mechanism.

Initially, the waste is prevented from exiting the waste treating apparatus 201 by a cover 64, which blocks the path from the temperature maintenance chamber 117 to the unloading mechanism 50. When the waste has spent a sufficient amount of time in the temperature maintenance chamber 117 to kill substantially all of the bacteria and viruses, the cover 64 is removed, allowing the waste to pass from the temperature maintenance chamber 117 to the unloading mechanism 50.

An additional aspect of these implementations concerns the unloading mechanism 50. In this implementation, the unloading mechanism 50 has a diameter that is less than the diameter of the microwave chamber 116. This results in a partial compaction of the waste while exiting the waste treating apparatus 201. To further increase compaction, a compactor 120 may optionally be added to the exit of the waste treating apparatus 201. Still another aspect of these implementations is the inclusion of a second, conductive, heating mechanism. This aspect includes a fluid reservoir 68, a fluid pump 71 and piping 69. Further, in this implementation, the microwave chamber 116 and temperature maintenance chamber 117 are double wall chambers having a gap between the walls. Fluid from the fluid reservoir 68 is pumped through the double wall of the temperature maintenance chamber 117, thereby being heated. It then flows through the double walls of the microwave chamber 116. In this manner, additional heat is added to the waste as it travels through the microwave chamber 116. Moreover, the conductive heating mechanism of this implementation may be used in combination with any of the other disclosed implementations even though it is only illustrated in this implementation.

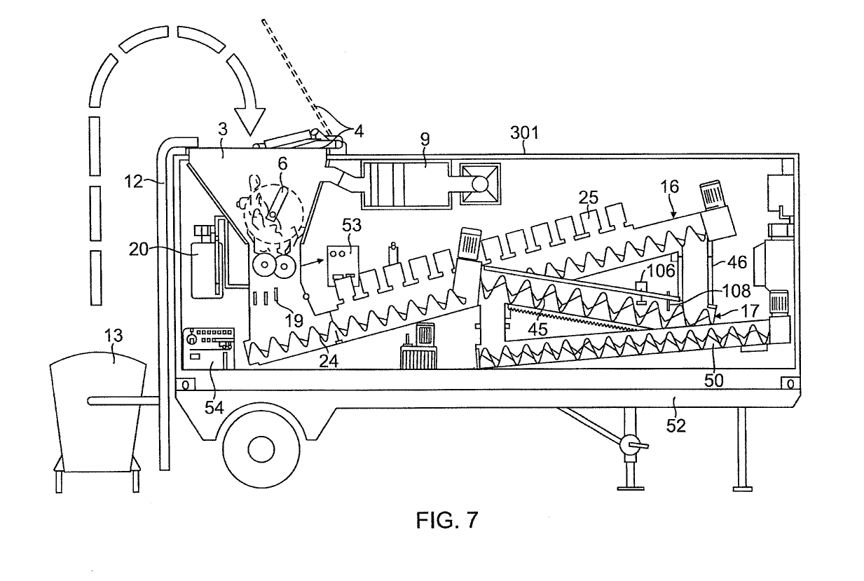

FIG. 7 illustrates additional implementations of a waste heat-treatment apparatus. In this example implementation, the waste treating apparatus 301 includes a secondary radiation source 106 added to the temperature maintenance chamber 17. The secondary radiation source 106 preferably is either a microwave or an infrared heat source. However, X-ray, radio waves and UV sources may be used as well. In addition to the secondary radiation source 106, the waste treating apparatus 301 may also include an ozone-generating electrode 108 either singly or in combination with the secondary radiation source 106. The ozone generated from the ozone-generating electrode 108 is highly oxidizing and is kill germs. Thus, the addition of the ozone-generating electrode 108 increases the likelihood that all of the bacteria and viruses in the medical waste are killed.

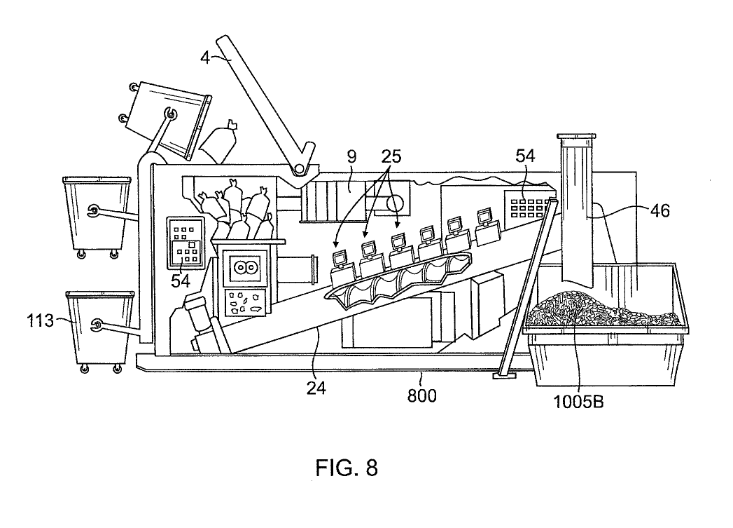

FIG. 8 depicts an example implementation of a waste heat-treatment apparatus 800, which is similar to waste heat-treatment apparatus 100 in many respects. The waste output by waste heat-treatment apparatus 800 is processed through a densifier, such as densifier 300, to provide a substantially dry, crystal-like output, which can use used as feedstock in the production of plastic and/or petroleum products.

As noted above, the waste material 1005B exiting the waste heat-treatment apparatus 800 is mechanically conveyed (e.g., via coupler 200) into the densifier 300. The waste material 1005B output by waste heat-treatment apparatus 800 is further reduced in size by the densifer 300.

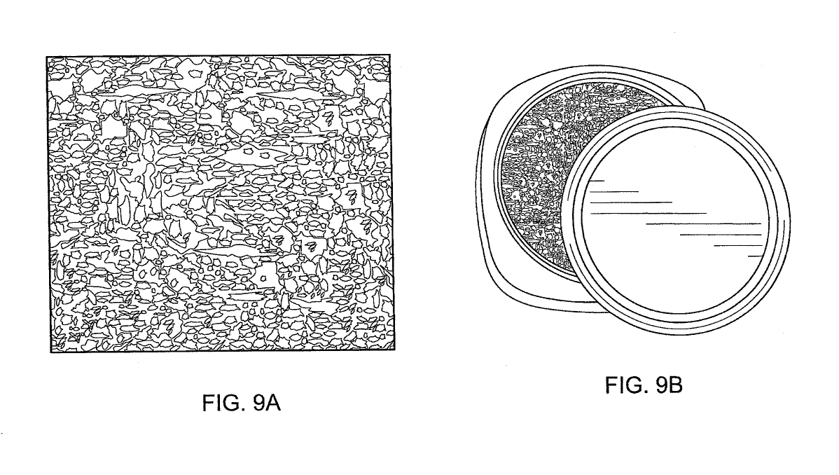

FIG. 9A depicts an example of the waste material 1005B output by waste heat-treatment apparatus 800, and FIG. 9B depicts an example of the substantially dry, crystal-like feedstock 1100 output by the densifier 300.

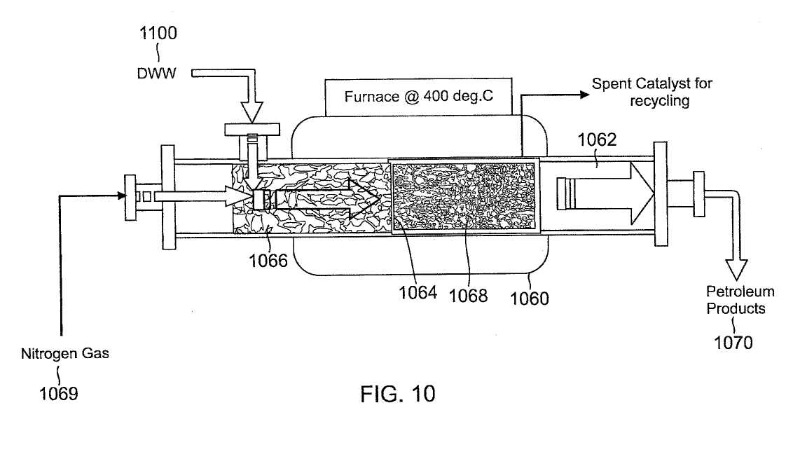

FIG. 10 depicts an example of a reactor 1060, which may be used to process the waste material feedstock 1100 by densifier 300 into a petroleum product 1070. The reactor 1060 exposes the densified waste 1100 to high heat and a catalyst 1068 enabling a conversion in an inert, nitrogen environment 1069 to petroleum product 1070. The plastics of the densified waste 1100 and the catalyst 1068 are separated by a screen 1064. The catalyst 1068 is on a solid support. The reactor furnace 1060 may be heated to about 400° C. and in some implementations to about 500° C. or more. The output fuel 1070 collects at the output 1062 of the reactor 1060.

In testing, the densified medical waste was converted into petroleum-based products 1070. Specifically, several samples of treated waste 1005B were first analyzed to determine the consistency of the different plastic fraction in the treated waste. In some example implementations, analysis may reveal that the majority of treated waste includes plastic comprising polyethylene (e.g., recycling codes 2 and 4) and polypropylene (e.g., code 5), making up at the least 80% of the bulk. Polyethylene made up the major portion of the treated waste (e.g., as high as 80-90% by weight). The next substantial plastic present in the treated waste 1005B was polystyrene (e.g., recycling code 6), which was between about 5-10%. The rest of the material of the treated waste 1005B includes nylon, polyurethane, some Bakelite type material and polyamides (code 7), making up less than 5-10% in the bulk, although there may be some small sulfur containing compounds as well. Thus, the high plastic content of the treated waste makes it suitable for plastic and/or fuel production.

A sample of a petroleum product 1070 generated using the densified feed stock 1100 was collected at about 400° C. with a boiling range of about 30 to 90° C. The petroleum product 1070 was analyzed, yielding the test results at Tables 1-2 below. Although example test data is depicted at Tables 1 and 2, the test data is only meant as an example.

Table 1 depicts the Derived Cetane Number (DCN) determination conducted using the petroleum industry fuel standard, DCN, ASTM D 6890. The DCN for commercial #2 Ultra-Low Sulfur Diesel is about 41.

Table 2 depicts example measurements of the physical characteristics of the petroleum product 1070 generated in accordance with the mechanisms and processes described herein.

The analysis may indicate that the petroleum product 1070 generated in accordance with the mechanisms and processes described herein provide a raw, unrefined petroleum product that is substantially commercial grade. Thus, the mechanisms and processes described herein may be used to convert medical waste into a densified medical waste, which is then processed into a plastic or petroleum product, such as unrefined fuel.

TABLE 1

| | DCN |
|---|---|
| Test 1: | 32.15 ± 0.38 |
| Test 2: | 31.87 ± 0.50 |
| Test 3: | 31.71 ± 0.46 |

TABLE 2

| | |
|---|---|
| Total Sulfur (ASTM D 2622) | 0.022% |
| Copper strip (Corrosion, ASTM D130) | 1A (no change) |
| Viscosity @ 100 F. (40 C.) (ASTM D445) | 0.735 centistokes |
| Viscosity @ 212 F. (100 C.) (ASTM D445) | 0.202 centistokes |
| Ash Content (ASTM D2974) | 2% |
| Moisture (ASTM D4017) | Not-detected |
| Flash point (ASTM D93) | <70° F. |
| Water (ASTM D4017) | 0.009% |

A pilot plant may be implemented to process medical waste into plastic and/or petroleum products, such as fuel. For example, about 10 pounds of feedstock from the densifier yields about one gallon of fuel.

The foregoing description is intended to illustrate but not to limit the scope of the invention, which is defined by the scope of the appended claims. Other embodiments are within the scope of the following claims.

What is claimed:

1. A method comprising:
heating medical waste to sanitize the medical waste;
providing the sanitized medical waste to a densifier; and
processing, at the densifier, by heating and shredding the sanitized medical waste to form a feedstock.

2. The method of claim 1, wherein the densifier heats and shreds the sanitized medical waste by spinning the sanitized medical waste.

3. The method of claim 2, wherein the densifier cools the heated sanitized medical waste to form the feedstock.

4. The method of claim 3, wherein the densifier cools the heated sanitized medical waste by adding, when the sanitized medical waste is at a temperature of about 205 degrees Celsius, a cooling fluid to the sanitized medical waste.

5. The method of claim 1 further comprising:
providing the feedstock to a reactor configured to generate a product comprising one or more petrochemical product.

6. The method of claim 1 further comprising:
providing the feedstock to a reactor configured to generate a diesel fuel.

7. The method of claim 1 further comprising:
providing the feedstock to a reactor configured to generate a gasoline fuel.

8. The method of claim 1 further comprising:
providing the feedstock to be mixed with virgin resins for plastic products manufacturing.

9. The method of claim 1, wherein the medical waste comprises one or more of the following: polyethylene, polypropylene, and polystyrene.

10. The method of claim 1, wherein the medical waste comprises one or more of the following: polyethylene, polypropylene, polystyrene, nylon, polyurethane, and polyamides.

11. The method of claim 1 further comprising:
providing the feedstock to a reactor; and
heating the feedstock to a temperature between about 400 degrees Celsius and about 500 degrees Celsius to form a petrochemical product.

12. A system comprising:
a heat-treatment apparatus configured to sanitize medical waste;
a coupler configured to receive sanitized waste and transport the sanitized medical waste; and
a densifier to process the sanitized medical waste into a feedstock.

13. The system of claim 12, wherein the densifier includes a deodorizer.

14. The system of claim 12, wherein the coupler includes a transport element, a heater, and a moisturizer.

15. The system of claim 12 further comprising:
a reactor including the feedstock, wherein the feedstock in the reactor is heated to a temperature between about 400 degrees Celsius and about 500 degrees Celsius to convert the feedstock into a petrochemical product.
